(19) United States
(12) Patent Application Publication
(10) Pub. No.: US 2008/0055652 A1
(43) Pub. Date: Mar. 6, 2008

(54) IMAGE FORMING DEVICE HAVING A FUNCTION FOR SUPPRESSING A DOCUMENT BACKGROUND AND METHOD THEREOF

(75) Inventor: Dong-ok KIM, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/691,023

(22) Filed: Mar. 26, 2007

(30) Foreign Application Priority Data
Sep. 1, 2006 (KR) 2006-84423

(51) Int. Cl. G06K 15/00

(52) U.S. Cl. 358/3.13

(57) ABSTRACT

An image forming device that has a function for suppressing a document background and performs binary coding of scan data using a dithering matrix, including a dithering matrix construction unit to divide the scan data into areas, set a threshold for each of the areas, and reconstruct a default dithering matrix using the threshold for each of the areas so as to generate a reconstructed dithering matrix for each of the areas; and a binary coding unit to compare the scan data with the reconstructed dithering matrix for each of the areas, and generate binary coded data based on a result of the comparison.

### CROSS-REFERENCE TO RELATED APPLICATIONS

This application claims the benefit of Korean Patent Application No. 2006-84423 filed on Sep. 1, 2006, in the Korean Intellectual Property Office, the disclosure of which is incorporated herein by reference in its entirety.

### BACKGROUND OF THE INVENTION

1. Field of the Invention

Aspects of the invention relate to an image forming device having a function for suppressing a document background and a method thereof. More particularly, aspects of the invention relate to an image forming device having a function for suppressing a document background by adaptively reconstructing a dithering matrix used to generate binary coded data and a method thereof.

2. Description of the Related Art

When copying documents having a non-white background, such as newsprint, using an image forming device, such as a printer, a digital copier, a facsimile machine, or a multifunctional product, the copies may have a low image quality caused by the darkness of the background, thereby resulting in a waste of a developer such as toner or ink. Therefore, an image forming device having a copying function may be provided with an automatic background suppression (ABS) function to produce copies having a better image quality.

In a flat-bed image forming device, a light source carriage may be moved to perform the ABS function. However, this method of performing the ABS function cannot be used in an automatic document supply mode in which an image is read by fixing the light source carriage in place and moving a document.

To improve the above ABS function, an advanced ABS function including a method of obtaining background information by reading a particular area of a leading end of a document using an image sensor, applying an adaptive gamma table to the background information, and suppressing a background has been suggested.

This advanced ABS function can be used in an automatic document supply mode. However, there is a problem in that the background of an entire document is suppressed based on background information of one particular area of the document, which causes the reliability of background suppression to decrease for a document in which there is a large difference between the backgrounds of different areas of the document.

That is, since not all documents have a uniform background over the entire document, an unusual background may be generated by the advanced ABS function, or a part of an image to be printed may not be printed.

### SUMMARY OF THE INVENTION

An aspect of the invention is to provide an image forming device having a function for suppressing a document background by adaptively reconstructing a dithering matrix used to generate binary code data and a method thereof.

According to an aspect of the invention, an image forming device that has a function for suppressing a document background and performs binary coding of scan data using a dithering matrix, comprises a dithering matrix construction unit to divide the scan data into areas, set a threshold for each of the areas, and reconstruct a default dithering matrix using the threshold for each of the areas so as to generate a reconstructed dithering matrix for each of the areas; and a binary coding unit to compare the scan data with the reconstructed dithering matrix for each of the areas, and generate binary coded data based on a result of the comparison.

According to an aspect of the invention, dithering matrix construction unit vertically divides the scan data in the areas based on a height of the default dithering matrix.

According to an aspect of the invention, a height of each of the areas is equal to a height of the default dithering matrix; and a width of each of the areas is equal to a width of the scan data.

According to an aspect of the invention, the dithering matrix construction unit sets an average value of pixels of the scan data in each one of the areas as the threshold for the one area.

According to an aspect of the invention, if a pixel value of the default dithering matrix is equal to or greater than the threshold for one of the areas, the dithering matrix construction unit changes the pixel value of the default dithering matrix to the threshold for the one area in the reconstructed dithering matrix for the one area; and, if the pixel value of the default dithering matrix is lower than the threshold for the one area, the dithering matrix construction unit normalizes the pixel value of the default dithering matrix to a normalized pixel value in the reconstructed dithering matrix for the one area within a gradation range having “0” as a minimum value and the threshold for the one area as a maximum value.

According to an aspect of the invention, the dithering matrix construction unit normalizes the pixel value of the default dithering matrix using the following equation:

$${X}_{ij} = {D}_{ij} \times \frac{N ( {V}_{th} )}{N ( 0 )}$$

where Xij is the normalized pixel value in the reconstructed dithering matrix for the one area, Dij is the pixel value of the default dithering matrix, N(Vth) is a number of gradations in the gradation range having “0” as the minimum value and the threshold for the one area as the maximum value, and N(0) is a number of gradations of the scan data.

According to an aspect of the invention, the binary coding unit is arranged to output a white value if a pixel value of the scan data is equal to or greater than a corresponding pixel value of the reconstructed dithering matrix for one of the areas, and to output a white value if the pixel value of the scan data is lower than the corresponding pixel value of the reconstructed dithering matrix for the one area.

According to an aspect of the invention, a method of suppressing a document background in an image forming device that performs binary coding of scan data using a dithering matrix, comprises dividing the scan data into areas; setting a threshold for each of the areas; reconstructing a default dithering matrix using the threshold for each of the areas so as to generate a reconstructed dithering matrix for each of the areas; comparing the scan data with the reconstructed dithering matrix for each of the areas; and generating binary coded data based on a result of the comparing.

According to an aspect of the invention, the dividing of the scan data into areas includes vertically dividing the scan data into the areas based on a height of the default dithering matrix.

According to an aspect of the invention, a height of each of the areas is equal to a height of the default dithering matrix; and a width of each of the areas is equal to a width of the scan data.

According to an aspect of the invention, the setting of threshold for each of the areas includes setting an average value of pixels of the scan data in each one of the areas as the threshold for the one area.

According to an aspect of the invention, the reconstructing of a default dithering matrix includes, if a pixel value of the default dithering matrix is equal to or greater than a threshold for one of the areas, changing the pixel value of the default dithering matrix to the threshold for the one area in the reconstructed dithering matrix for the one area; and if the pixel value of the default dithering matrix is lower than the threshold for the one area, normalizing the pixel value of the default dithering matrix to a normalized pixel value in the reconstructed dithering matrix for the one area within a gradation range having “0” as a minimum value and the threshold for the one area as a maximum value.

According to an aspect of the invention, the normalizing of the default dithering matrix includes normalizing the pixel value of the default dithering matrix using the following equation:

$${X}_{ij} = {D}_{ij} \times \frac{N ( {V}_{th} )}{N ( 0 )}$$

where Xij is the normalized pixel value in the reconstructed dithering matrix, Dij is the pixel value of the default dithering matrix, N(Vth) is a number of gradations in the gradation range having “0” as the minimum value and the threshold for the one area as the maximum value, and N(0) is a number of gradations of the scan data.

According to an aspect of the invention, the generating of binary coded data includes, if a pixel value of the scan data is equal to or greater than a corresponding pixel value of the reconstructed dithering matrix for one of the areas, outputting a white value; and if the pixel value of the scan data is lower than the corresponding pixel value of the reconstructed dithering matrix for the one area, outputting a black value.

According to an aspect of the invention, an image forming device for forming an image of a document is provided. The image forming device comprises a dithering matrix construction unit arranged to divide scan data obtained from the document into a plurality of areas, set a respective threshold for each of the areas, and reconstruct a default dithering matrix based on the respective threshold for each of the areas so as to generate a respective reconstructed dithering matrix for each of the areas that is effective to suppress a background of the document within a respective one of the areas; and a binary coding unit to compare the scan data in each one of the areas with the respective reconstructed dithering matrix for the one of the areas, and generate binary coded data based on a result of the comparison.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of embodiments of the invention, taken in conjunction with the accompanying drawings of which:

FIG. 1 is a block diagram of an image forming device having a function for suppressing a document background according to an aspect of the invention;

FIGS. 2A and 2B show a method of dividing scan data into areas according to an aspect of the invention;

FIGS. 3A-3D show a method of generating binary coded data using a dithering matrix according to an aspect of the invention; and

FIG. 4 is a flow chart of a method of suppressing a document background in an image forming device according to an aspect of the invention.

### DETAILED DESCRIPTION OF THE EMBODIMENTS

Reference will now be made in detail to embodiments of the invention, examples of which are shown in the accompanying drawings, wherein like reference numerals refer to like elements throughout. The embodiments are described below in order to explain the invention by referring to the figures.

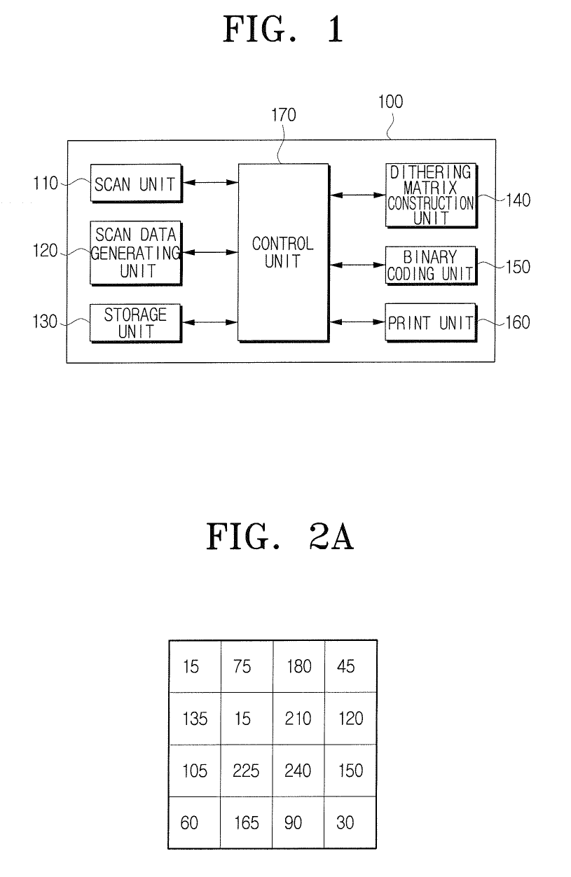

FIG. 1 is a block diagram of an image forming device having a function for suppressing a document background according to an aspect of the invention.

Referring to FIG. 1, an image forming device 100 comprises a scan unit 110, a scan data generating unit 120, a storage unit 130, a dithering matrix construction unit 140, a binary coding unit 150, a print unit 160, and a control unit 170.

The scan unit 110 scans a document and generates a scan image. The scan unit 110 may be a flat-bed type in which documents are individually loaded and scanned one at a time, or an automatic feeder type in which a plurality of documents are loaded at once and are automatically scanned one after the other.

Typically, the scan unit 110 comprises an image sensor such as a charge-coupled device (CCD) or a contact image sensor (CIS), and generates a pattern of pixels corresponding to an image of a document by using the image sensor to perform photoelectric conversion of light reflected from the document to generate an image signal having a voltage that is proportional to the amount of the reflected light.

The scan data generating unit 120 generates scan data for each pixel from the scan image generated by the scan unit 110. Typically, the scan data generating unit 120 generates the scan data by sampling, quantizing, and coding a voltage of the image signal corresponding to each pixel of the scan image.

The storage unit 130 stores a default dithering matrix used when performing dithering in the image forming device 100. The storage unit 130 may also store a reconstructed dithering matrix generated by the dithering matrix construction unit 140 separately from the stored default dithering matrix.

The dithering matrix construction unit 140 divides the scan data generated by the scan data generating unit 120 into areas, and sets a threshold for each area.

More specifically, the dithering matrix construction unit 140 divides the scan data vertically based on a height of the default dithering matrix stored in the storage unit 130, that is, based on the number of rows of pixels of the default dithering matrix stored in the storage unit 130, and does not divide the scan data horizontally.

For example, if the height×width of the default dithering matrix stored in the storage unit 130 is 10×10 pixels and that of the scan data is 400×400 pixels, the dithering matrix construction unit 140 divides the scan data vertically into 40 areas of 10×400 pixels, that is, into 40 areas having a height of 10 pixels and a width of 400 pixels. This is particularly effective when a document has a background that is substantially uniform across the width of the document at any particular place along the length of the document, but varies from place to place along the length of the document.

The dithering matrix construction unit 140 reconstructs the default dithering matrix stored in the storage unit 130 using the thresholds set for each area to generate a reconstructed dithering matrix for each area. The dithering matrix construction unit 140 calculates the average value of the pixels of the scan data for each area, and sets the threshold for each area to the average value of the pixels for each area. Although in this example, the threshold for each area is set to the average value of the pixels in each area, the invention is not limited to this, and the threshold for each area can be set to any value determined based on the values of the pixels in each area. For example, the threshold for each area can be set to the median value of the pixels in each area, or to the mode value of the pixels in each area, or to a weighted average of the pixels in each area. Such a weighted average can be calculated using any desired weighting.

If a pixel value of the default dithering matrix stored in the storage unit 130 is equal to or greater than the threshold for an area, the dithering matrix construction unit 140 changes the pixel value of the default dithering matrix to the threshold in a reconstructed dithering matrix for that area. Conversely, if the pixel value of the default dithering matrix stored in the storage unit 130 is lower than the threshold, the dithering matrix construction unit 140 normalizes the pixel value of the default dithering matrix to a value within a range of gradations having “0” as a minimum value and the threshold as a maximum value in the reconstructed dithering matrix for that area. The default dithering matrix which is compared with the threshold by the dithering matrix construction unit 140 is pre-stored in the storage unit 130.

The dithering matrix construction unit 140 may use the following Equation 1 to normalize the pixel value of the default dithering matrix to a value within the range of gradations having “0” as the minimum value and the threshold as the maximum value:

$${X}_{ij} = {D}_{ij} \times \frac{N ( {V}_{th} )}{N ( 0 )} \qquad ( 1 )$$

where Xij is the normalized value of the pixel value in the ith line and the jth column of the reconstructed dithering matrix, Dij is the pixel value in the ith line and the jth column of the default dithering matrix stored in the storage unit 130, N(Vth) is the number of gradations in the range of gradations having “0” as the minimum value and the threshold as the maximum value, and N(0) is the number of gradations of the scan data. Since the gradations of the scan data typically range from 0˜255, N(0) is typically 256. In addition, since the gradations having “0” as the minimum value and the threshold as the maximum value range from 0˜threshold, N(Vth) is threshold+1.

For example, if a pixel value Dij of the default dithering matrix stored in the storage unit 130 is 15 and a threshold for an area is 120, N(Vth) is 121 (=120+1) and the normalized value Xij is approximately 7 (=15×( 121/256)). That is, the normalized value of the pixel value of the reconstructed dithering matrix is determined by adjusting the pixel value of the default based on the number of gradations of the scan data and the number of gradations in a range of gradations having o as a minimum value and the threshold as the maximum value.

The dithering matrix construction unit 140 reconstructs the default dithering matrix for each area using the threshold for each area to generate a reconstructed dithering matrix for each area to be used for binary coding of the scan data of each area. That is, the scan data is binary coded by applying a different dithering matrix to each area using a reconstructed dithering matrix for each area generated by the dithering matrix construction unit 140.

The binary coding unit 150 compares the scan data generated by the scan data generating unit 120 with the reconstructed dithering matrix generated by the dithering matrix construction unit 140 for each area pixel by pixel to generate binary coded data for each area.

If the scan data of a pixel is equal to or greater than the corresponding pixel value of the reconstructed dithering matrix, the binary coding unit 150 outputs a white value. Conversely, if the scan data of the pixel is lower than the corresponding pixel value of the reconstructed dithering matrix, the binary coding unit 150 outputs a black value. However, the invention is not limited to this, and the binary coding unit 150 can output a black value in place of the white value, and can output a white value in place of the black value.

The print unit 160 performs printing using the binary coded data generated by the binary coding unit 150.

The control unit 170 controls the overall operation of the image forming device 100, and controls input and output of signals between the scan unit 110, the scan data generating unit 120, the storage unit 130, the dithering matrix construction unit 140, the binary coding unit 150, and the print unit 160.

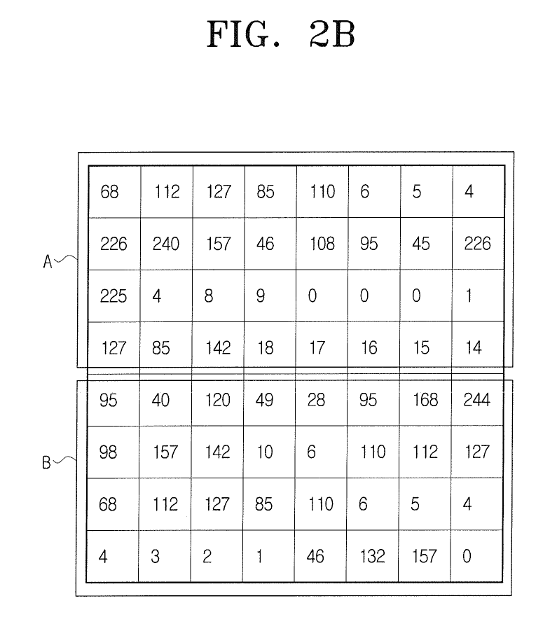

FIGS. 2A and 2B show a method of dividing scan data into areas according to an aspect of the invention.

FIG. 2A is an example of a default dithering matrix typically used for dithering which is pre-stored in the storage unit 130. In this example, a dithering matrix of 4×4 pixels is shown for convenience of explanation. However, the invention is not limited to a dithering matrix of 4×4 pixels, and a dithering matrix having any number of pixels can be used. Also, the invention is not limited to a square dithering matrix as shown in FIG. 2A, and a rectangular dithering matrix, an irregular dithering matrix, or a dithering matrix having any other configuration can be used.

FIG. 2B shows an example of scan data in an 8×8 matrix. Each of the pixels of the scan data has a gradation, i.e., a value, within a range of gradations from 0˜255 that is generated by the scan data generating unit 120 using a scan image generated by the scan unit 110.

Since the size of the default dithering matrix in FIG. 2A is 4×4 pixels, the dithering matrix construction unit 140 divides the scan data in FIG. 2B into an area A and an area B each having a size of 4×8 pixels as shown in FIG. 2B. Next, the dithering matrix construction unit 140 calculates the average value of the pixels of the scan data for each of the area A and the area B, and sets a threshold for each of the area A and the area B to the average value calculated for each of the area A and the area B. For example, the average value of the pixels for the area A is 73.15625 (= 2341/32), and the threshold for the area A may be set to 73 by truncating the decimal portion. Also, the average value of the pixels for the area B is 76.96875 (= 2463/32), and the threshold for the area B may be set to 76 by truncating the decimal portion. Alternatively, the threshold can be set using a rounding method in which the threshold is rounded up to the higher whole value if the decimal portion is 0.5 or greater, and is rounded down to the next lower whole value ff the fractional portion of the average value is 0.4 or less. Using this rounding method, the threshold for the area A would be set to 73 and the threshold for the area B would be set to 77. However, any rounding method may be used in place of the truncating method.

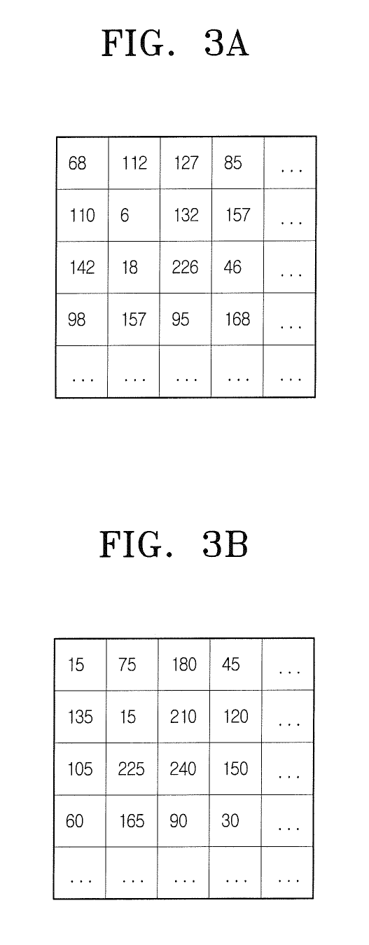

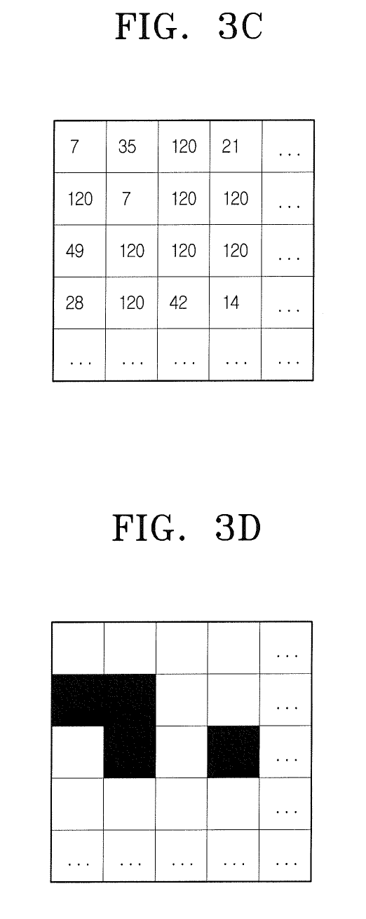

FIGS. 3A-3D show a method of generating binary coded data using a dithering matrix according to an aspect of the invention.

More specifically, FIG. 3A shows an example of scan data of n×n pixels, FIG. 3B shows an example of a default dithering matrix, FIG. 3C shows an example of a reconstructed dithering matrix generated from the default dithering matrix of FIG. 3B based on the scan data in FIG. 3A, and FIG. 3D shows an example of binary coded data of n×n pixels generated by applying the reconstructed dithering matrix in FIG. 3C to the scan data in FIG. 3A.

The scan unit 110 scans a document and generates a scan image, and the scan data generating unit 120 generates scan data as shown in FIG. 3A in which each pixel has a gradation in a range of 0˜255.

FIG. 3B shows an example of a default dithering matrix which is pre-stored in the storage unit 130. If the default dithering matrix in FIG. 3B is reconstructed by the dithering matrix construction unit 140 based on the scan data in FIG. 3A, a reconstructed dithering matrix as shown in FIG. 3C is generated. In this case, the reconstructed dithering matrix in FIG. 3C has been generated based on a threshold of 120 as can be seen from the fact that all values in the default dithering matrix in FIG. 3B exceeding 120 have been replaced with a value of 120 in the reconstructed dithering matrix in FIG. 3C. This threshold of 120 means that the average value of the pixels of the scan data of n×n pixels shown in FIG. 3A is 120. Although the average value of the 4×4 pixels actually shown in FIG. 3A is only 109.1875 (= 1747/16), these 4×4 pixels are only part of the n×n pixels, and the average value of the n×n pixels including the 4×4 pixels that are actually shown in FIG. 3A and the other pixels that are not shown in FIG. 3A is 120.

When the binary coding unit 150 compares the scan data in FIG. 3A with the reconstructed dithering matrix in FIG. 3C pixel by pixel, binary coded data as shown in FIG. 3D is generated.

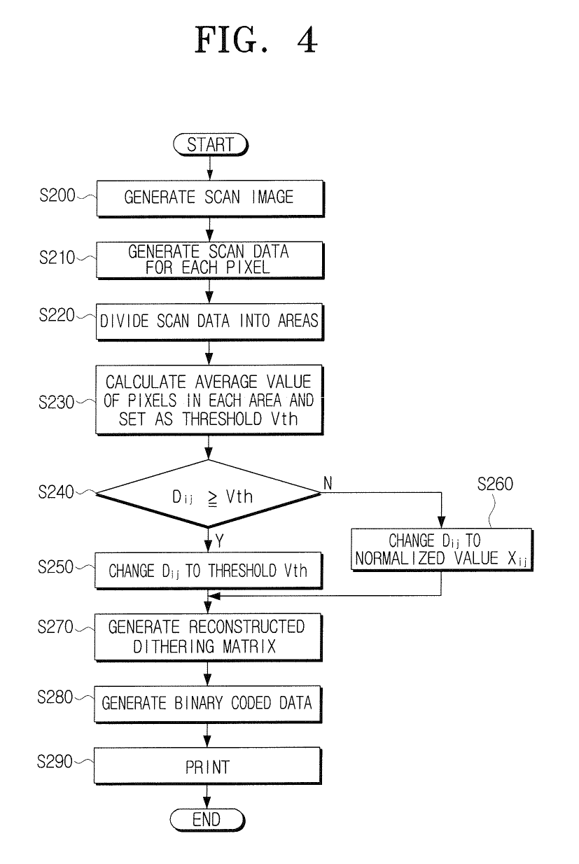

FIG. 4 is a flow chart of a method of suppressing a document background in an image forming device according to an aspect of the invention.

When a user loads a document to copied into the image forming device 100 and inputs a copy command, the scan unit 110 in FIG. 1 scans the document and generates a scan image (operation S200).

The scan data generating unit in FIG. 1 generates scan data having gradations of 0˜255 from the scan image (operation S210).

The dithering matrix construction unit 140 in FIG. 1 divides the scan data into areas having a height in pixels equal to a height in pixels of a default dithering matrix pre-stored in the storage unit 130 in FIG. 1. A method of dividing the scan data into areas has already been described with reference to FIGS. 2A and 2B (operation S220). FIG. 3A shows an example of a portion of the scan data of one such area.

Next, the dithering matrix construction unit 140 calculates the average value of the pixels of the scan data in each area and sets the average value as a threshold Vth for each area (operation S230).

The dithering matrix construction unit 140 compares a pixel value Dij of the default dithering matrix stored in the storage unit 130 with the threshold Vth (operation S240). FIG. 3B shows an example of such a default dithering matrix.

In the operation S240, if the pixel value Dij of the default dithering matrix stored in the storage unit 130 is equal to or greater than the threshold Vth (operation S240-Y), the dithering matrix construction unit 140 changes the pixel value Dij of the default dithering matrix to the threshold Vth (operation S250).

Alternatively, in the operation S240, if the pixel value Dij of the default dithering matrix stored in the storage unit 130 is lower than the threshold Vth (operation S240-N), the dithering matrix construction unit 140 changes the pixel value Dij of the default dithering matrix to a normalized value Xij. The normalized value Xij of the pixel value Dij is determined by multiplying the pixel value Dij by a ratio of the number of gradations in a range of gradations having “0” as a minimum value and the threshold Vth as a maximum value to the number of gradations (typically 256) of the scan data (typically having a range of gradations of 0˜255) in accordance with Equation 1 (operation S260).

The dithering matrix construction unit 140 performs the operations S250 and S260 for all of the pixels of the scan data for each area. As a result, a reconstructed dithering matrix is generated for each area (operation S270). FIG. 3C shows an example of such a reconstructed dithering matrix.

The binary coding unit 150 in FIG. 1 compares the scan data for each area with the reconstructed dithering matrix for each area pixel by pixel and generates binary coded data.

FIG. 3D shows an example of such binary coded data produced by comparing the scan data in FIG. 3A with the reconstructed dithering matrix in FIG. 3C. Binary coding is performed for each area using the reconstructed dithering matrix for each area generated by the dithering matrix construction unit 140 (operation S280).

Next, the print unit 160 prints the document using the binary coded data (operation S290).

As described above, all of the scan data is binary coded by applying an adaptively reconstructed dithering matrix generated for each of a plurality of areas into which the scan data is divided, so that the background of a document having a high variation in brightness can be effectively suppressed.

As can be appreciated from the above description, in an image forming device having a function for suppressing a document background and a method thereof according to an aspect of the invention, scan data is divided into areas, and an adaptively reconstructed dithering matrix is generated for each of the areas and is used to perform binary coding of the scan data. Accordingly, an output image having a higher quality can be obtained, particularly for a document with a background having a high variation in brightness.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. An image forming device that has a function for suppressing a document background and performs binary coding of scan data using a dithering matrix, the image forming device comprising:
a dithering matrix construction unit to divide the scan data into areas, set a threshold for each of the areas, and reconstruct a default dithering matrix using the threshold for each of the areas so as to generate a reconstructed dithering matrix for each of the areas; and
a binary coding unit to compare the scan data with the reconstructed dithering matrix for each of the areas, and generate binary coded data based on a result of the comparison.

2. The image forming device of claim 1, wherein the dithering matrix construction unit vertically divides the scan data into the areas based on a height of the default dithering matrix.

3. The image forming unit of claim 2, wherein a height of each of the areas is equal to a height of the default dithering matrix; and
wherein a width of each of the areas is equal to a width of the scan data.

4. The image forming device of claim 1, wherein the dithering matrix construction unit sets an average value of pixels of the scan data in each one of the areas as the threshold for the one area.

5. The image forming device of claim 1, wherein, if a pixel value of the default dithering matrix is equal to or greater than the threshold for one of the areas, the dithering matrix construction unit changes the pixel value of the default dithering matrix to the threshold; and
wherein, if the pixel value of the default dithering matrix is lower than the threshold for the one area, the dithering matrix construction unit normalizes the pixel value of the default dithering matrix to a normalized pixel value in the reconstructed dithering matrix for the one area within a gradation range having “0” as a minimum value and the threshold for the one area as a maximum value.

6. The image forming device of claim 5, wherein the dithering matrix construction unit normalizes the pixel value of the default dithering matrix using the following equation:
$${X}_{ij} = {D}_{ij} \times \frac{N ( {V}_{th} )}{N ( 0 )}$$
where Xij is the normalized pixel value in the reconstructed dithering matrix for the one area, Dij is the pixel value of the default dithering matrix, N(Vth) is a number of gradations in the gradation range having “0” as the minimum value and the threshold for the one area as the maximum value, and N(0) is a number of gradations of the scan data.

7. The image forming device of claim 1, wherein, if a pixel value of the scan data is equal to or greater than a corresponding pixel value of the reconstructed dithering matrix for one of the areas, the binary coding unit outputs a white value; and
wherein, if the pixel value of the scan data is lower than the corresponding pixel value of the reconstructed dithering matrix for the one area, the binary coding unit outputs a black value.

8. A method of suppressing a document background in an image forming device that performs binary coding of scan data using a dithering matrix, the method comprising:
dividing the scan data into areas;
setting a threshold for each of the areas;
reconstructing a default dithering matrix using the threshold for each of the areas so as to generate a reconstructed dithering matrix for each of the areas;
comparing the scan data with the reconstructed dithering matrix for each of the areas; and
generating binary coded data based on a result of the comparing.

9. The method of claim 8, wherein the dividing of the scan data into areas comprises vertically dividing the scan data into the areas based on a height of the default dithering matrix.

10. The method of claim 9, wherein a height of each of the areas is equal to a height of the default dithering matrix; and
wherein a width of each of the areas is equal to a width of the scan data.

11. The method of claim 8, wherein the setting of a threshold for each of the areas comprises setting an average value of pixels of the scan data in each one of the areas as the threshold for the one area.

12. The method of claim 8, wherein the reconstructing of a default dithering matrix comprises:
if a pixel value of the default dithering matrix is equal to or greater than the threshold for one of the areas, changing the pixel value of the default dithering to the threshold for the one area in the reconstructed dithering matrix for the one area; and
if the pixel value of the default dithering matrix is lower than the threshold for the one area, normalizing the pixel value of the default dithering matrix to a normalized pixel value in the reconstructed dithering matrix for the one area within a gradation range having “0” as a minimum value and the threshold for the one area as a maximum value.

13. The method of claim 12, wherein the normalizing of the pixel value of the default dithering matrix comprises normalizing the pixel value of the default dithering matrix using the following equation:
$${X}_{ij} = {D}_{ij} \times \frac{N ( {V}_{th} )}{N ( 0 )}$$
where Xij is the normalized pixel value in the reconstructed dithering matrix for the one area, Dij is the pixel value of the default dithering matrix, N(Vth) is a number of gradations in the gradation range having “0” as the minimum value and the threshold for the one area as the maximum value, and N(0) is a number of gradations of the scan data.

14. The method of claim 8, wherein the generating of binary coded data comprises:
if a pixel value of the scan data is equal to or greater than a corresponding pixel value of the reconstructed dithering matrix for one of the areas, outputting a white value; and
if the pixel value of the scan data is lower than the corresponding pixel value of the reconstructed dithering matrix for the one area, outputting a black value.

15. An image forming device for forming an image of a document, comprising:
a dithering matrix construction unit arranged to divide scan data obtained from the document into a plurality of areas, set a respective threshold for each of the areas, and reconstruct a default dithering matrix based on the respective threshold for each of the areas so as to generate a respective reconstructed dithering matrix for each of the areas that is effective to suppress a background of the document within a respective one of the areas; and
a binary coding unit to compare the scan data in each one of the areas with the respective reconstructed dithering matrix for the one of the areas, and generate binary coded data based on a result of the comparison.

16. The image forming device of claim 15, further comprising:
a scan unit to scan the document so as to obtain a scan image of the document; and
a scan data generating unit to generate the scan data of the document from the scan image of the document.

17. The image forming device of claim 15, further comprising a storage unit to store the default dithering matrix.

18. The image forming device of claim 17, wherein the storage unit also stores the respective reconstructed dithering matrix for each of the areas.

19. The image forming device of claim 15, further comprising a print unit to print an image of the document based on the binary coded data.

20. The image forming device of claim 19, wherein the image of the document printed by the print unit is a dithered binary image of the document.

21. The image forming device of claim 15, wherein the dithering matrix construction unit vertically divides the scan data into the areas so that a height of each of the areas is equal to a height of the default dithering matrix.

22. The image forming device of claim 15, wherein the dithering matrix construction unit does not horizontally divide the scan data so that a width of each of the areas is greater than a width of the default dithering matrix and is equal to a width of the scan data.

23. The image forming device of claim 15, wherein each of the areas comprises a plurality of pixels of scan data; and
wherein the dithering matrix construction unit sets the respective threshold for each of the areas based on pixel values of the pixels of the a respective one of the areas.

24. The image forming device of claim 23, wherein the dithering matrix construction unit sets the respective threshold for each of the pixels to be equal to an average of the pixel values of all of the pixels of the respective one of the areas.

25. The image forming device of claim 15, wherein the dithering matrix construction unit generates the respective reconstructed dithering matrix for each of the areas by setting pixel values of the reconstructed dithering matrix for each one of the areas so that:
if a pixel value of the default dithering matrix is equal to or greater than the respective threshold for the one area, a corresponding pixel value of the reconstructed dithering matrix for the one area is set to the respective threshold for the one area, and
if the pixel value of the default dithering matrix is lower than the respective threshold for the one area, the corresponding pixel value of the reconstructed dithering matrix for the one area is set to a normalized pixel value within a gradation range having “0” as a minimum value and the respective threshold for the one area as a maximum value.

26. The image forming device of claim 25, wherein the dithering matrix construction unit obtains the normalized pixel value using the following equation:
$${X}_{ij} = {D}_{ij} \times \frac{N ( {V}_{th} )}{N ( 0 )}$$
where Xij is the normalized pixel value in the reconstructed dithering matrix for the one area, Dij is the pixel value of the default dithering matrix, N(Vth) is a number of gradations in the gradation range having “0” as the minimum value and the threshold for the one area as the maximum value, and N(O) is a number of gradations of the scan data.

27. The image forming device of claim 25, wherein the respective reconstructed dithering matrix for each of the areas has a same number of pixels, a same size, and a same shape as the default dithering matrix.

28. The image forming device of claim 15, wherein the binary coding unit generates binary coded data having a white value corresponding to a pixel of the scan data if a pixel value of the pixel of the scan data is equal to or greater than a pixel value of a corresponding pixel of the reconstructed dithering matrix for one of the areas; and
wherein the binary coding unit generates binary coded data having a black value corresponding to the pixel of the scan data if the pixel value of the pixel of the scan data is lower than the pixel value of the corresponding pixel of the reconstructed dithering matrix for the one area.
